(19) United States
(12) Patent Application Publication
(10) Pub. No.: US 2008/0059458 A1
(43) Pub. Date: Mar. 6, 2008

(54) Folksonomy weighted search and advertisement placement system and method

(76) Inventor: Robert V. Byron, Plano, TX (US)

Correspondence Address: JACKSON WALKER LLP, 901 MAIN STREET, SUITE 6000, DALLAS, TX, 75202-3797, US

(21) Appl. No.: 11/899,461

(22) Filed: Sep. 6, 2007

Related U.S. Application Data
(60) Provisional application No. 60/842,607, filed on Sep. 6, 2006.
(60) Provisional application No. 60/842,605, filed on Sep. 6, 2006.
(60) Provisional application No. 60/842,604, filed on Sep. 6, 2006.

(51) Int. Cl. G06F 17/30

(52) U.S. Cl. 707/5; 707/E17.017

(57) ABSTRACT

A method for folksonomy weighted searching is provided. The method includes identifying two or more Internet resources associated with a folksonomy. One or more words or phrases are identified in the Internet resources. The words or phrases are weighted based on a frequency of use, and a database is generated associating the words or phrases with at least one of the Internet resources.

### PRIORITY CLAIM

This application claims priority of U.S. Provisional Patent Application Ser. No. 60/842,607, entitled “DYNAMIC TAXONOMY SYSTEM AND METHOD” filed Sep. 6, 2006, U.S. Provisional Patent Application Ser. No. 60/842,605, entitled “DYNAMIC TAXONOMY AD PLACEMENT SYSTEM AND METHOD” filed Sep. 6, 2006, U.S. Provisional Patent Application Ser. No. 60/842,604, entitled “DYNAMIC TAXONOMY WEIGHTED SEARCHING SYSTEM AND METHOD” filed Sep. 6, 2006, the teachings of which are incorporated herein by reference.

### FIELD OF THE INVENTION

The present invention is generally related to weighted search and ad placement, and more specifically to the use of information generated by social networking using the Internet to weight search and ad placement functions and algorithms.

### BACKGROUND OF THE INVENTION

The advent of the Internet has facilitated many types of communication. One form of communication that has been facilitated by the Internet is communication among those sharing a common interest. For example, those who have an interest in a certain type of dog may exchange information about that breed of dog or simply share stories or answer simple questions regarding the care of the certain breed of dog. In addition, those knowing about additional resources with regard to the certain breed of dog may share those resources with others having an interest in the same breed of dog. Others may openly communicate to solicit responses to questions or comments about the breed of dog from anyone sharing a similar interest.

One of the problems with using the Internet for searching for information about a specific topic is that most search engines effectively start from the beginning each time any type of communication is initiated. Specifically, following an initial search for information on a particular topic, subsequent searches begin at the same starting point as the initial search.

In addition to the foregoing problem of establishing and re-establishing a foundation for doing a search for information on the Internet, there is the problem of the continual changing meanings of words and phrases over time. Thus, a word or a phrase that has what a searcher believes to be an accepted meaning may grow or change to have a different meaning over time. An extension of this phenomenon is the introduction of new words or phrases, heretofore not used, to describe something that is either well-known or new.

The changing meaning of words and phrases or the introduction of new words and phrases is particularly problematic for those seeking to find information on the Internet. Specifically, according to the state of the art, each Internet search begins with a word or series of words that a search engine compares to the content of websites and then reports back to the requester when a match has occurred. Anyone who has used a search engine on the Internet has experienced the frustration of receiving more “hits” than can possibly be reviewed in a reasonable amount of time. The problem is that the information being sought by a searcher may be in one of the “hits” but the sheer number of the “hits” masks the location of the sought-after information.

### SUMMARY OF INVENTION

The present invention achieves technical advantages as a folksonomy weighted search and ad placement system and method. In one exemplary embodiment of the invention, the Internet is used to enable those with an interest in a particular area to be assisted in obtaining information that will not require starting out with simply a word or a phrase.

Folksonomy is the practice and method of collaborative categorization using freely-chosen keywords called tags. Folksonomy is a portmanteau that refers to the tagging systems created within Internet communities, and is a compilation of the words “folk” and “taxonomy.” As such, folksonomy is a type of dynamic taxonomy that results from the interaction of persons within Internet communities.

The system and method of the present invention is based on the use of a folksonomy to determine the weight to be given to words and phrases to better enable those using a search engine to retrieve relevant subject matter, and to optimize the delivery of advertising to persons having interest in the advertised subject matter.

The folksonomy weighted search and advertisement placement system and method of the present invention utilizes a weighted compilation of words and phrases extracted from a list of references, including but not limited to websites, blogs, forums, news feeds, databases, or other applications. The words or phrases derived from the list of references are then used to compile one or more lists that can be used to facilitate searching and ad placement.

Because users that share similar interests tend to use similar words or phrases, the words and phrases on the list include words and phrases associated with the interests of those using predetermined websites, blogs, forums, news feeds, databases, or other suitable data sources that are built around a common interest. Unlike a static taxonomy, the folksonomy weighted search and advertisement placement system and method of the present invention will adjust the words or phrases on the list by frequency of use over time, adjust the weight of certain words and phrases, and add or delete words and phrases.

### BRIEF DESCRIPTION OF THE DRAWINGS

FIG. 1 is a diagram of a method for providing a folksonomy system in accordance with an exemplary embodiment of the present invention;

FIG. 2 is a diagram of a method for providing a folksonomy searching system in accordance with an exemplary embodiment of the present invention;

FIG. 3 is a diagram of a method for providing a folksonomy advertisement placement system in accordance with an exemplary embodiment of the present invention; and

FIG. 4 is a diagram of a system for providing folksonomy weighted search and advertisement placement in accordance with an exemplary embodiment of the present invention.

### DETAILED DESCRIPTION OF THE PRESENT INVENTION

In the disclosed folksonomy weighted search and ad placement system and method, which may be personal to a user or group of users, the words on the list extracted from the references can change each time the extraction is retrieved. Additionally, the weighting of individual words can be augmented each time an extraction is retrieved wherein an initial weighting is assigned from frequency of use and subsequent weightings can be added at a later time.

Regarding the timing of the changing of the words on the list, the dynamic nature of the system and method of the present invention allows for changes to be made at any time, or periodically.

Regarding the weighting of certain words or phrases, an absolute or a relative weight can be added to any word or phrase to increase or decrease its weight. An absolute weight can be used to override any future calculated weight whereas a relative weight can be used to either increase or decrease the weight given to a word or phrase.

Further, an initial date may be added to a word or phrase as an attribute of the word or phrase denoting the first time that the word or phrase was detected. Similarly, a last seen date may be added denoting the last time that a word or phrase was detected. The dating of the word or phrase can be used to modify the weight assigned to a particular word or phrase.

Additionally, a grammatical syntax may be assigned to a word or phrase to determine how the word is used in a sentence, i.e. noun, verb, adjective, or other suitable grammatical categories.

Accordingly, by the creation of a list of words and phrases most frequently used and weighting words and phrases most frequently used, the folksonomy system and method of the present invention emulates the way people of common interest use words and phrases to describe things related to their common interest.

To further clarify and refine a folksonomy weighted search and advertisement placement system and method, it is possible to delete certain words entirely such as profanity.

Other words or phrases may not be descriptive, but rather are used simply to string other words or phrases together to communicate an idea. Such words or phrases are called stop words or phrases and can be eliminated when creating a list of words or phrases and weighting the words or phrases.

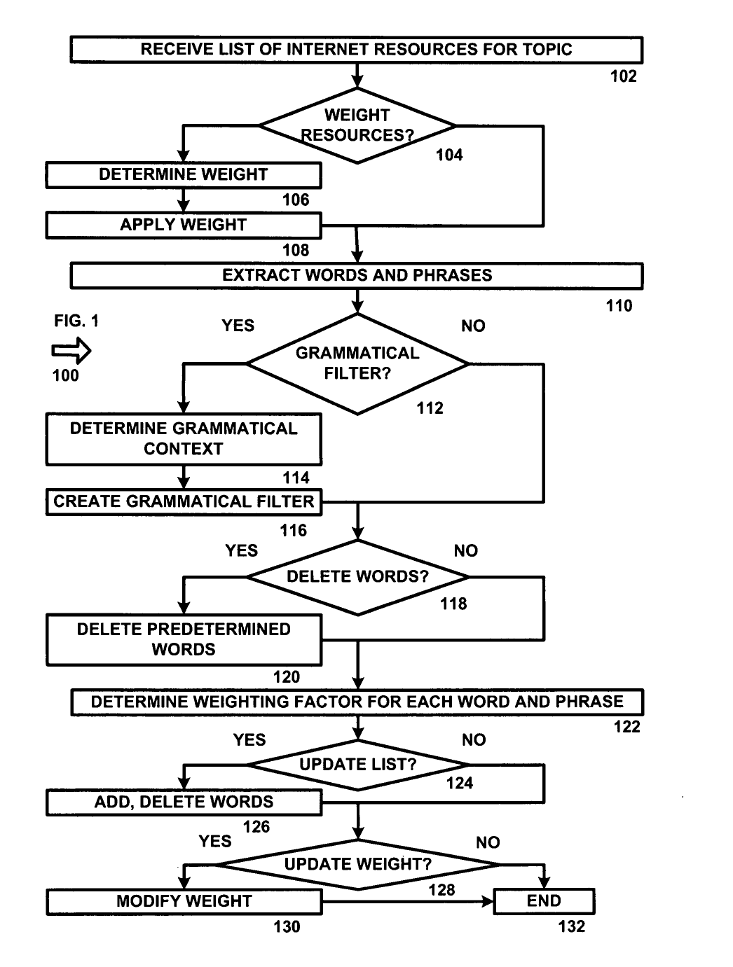

FIG. 1 is a diagram of a method 100 for providing a folksonomy system in accordance with an exemplary embodiment of the present invention. Method 100 can be implemented as an algorithm on a general purpose computing platform or other suitable systems.

Method 100 begins at 102, where a list of Internet resources is received for a topic. In one exemplary embodiment, the Internet resources can include predetermined websites, blogs, forums, news feeds, databases, or other suitable data sources that are built around a common interest. In another exemplary embodiment, websites, blogs, forums, news feeds, databases, or other suitable data sources can be located in a suitable manner, can be reviewed for suitable content, or other suitable processes can be used. The method then proceeds to 104.

At 104, it is determined whether the resources should be weighted. If weighting of resources is not performed, the method proceeds to 110. Otherwise, the method proceeds to 106 where a weight for one or more resources is determined. In one exemplary embodiment, weights can be assigned based on the type of resource, the extent to which the resource is used, the content of the resource, the relevance of the resource to the topic, or other suitable data. In another exemplary embodiment, an associative database can be used to associate words and phrases with Internet resources, and resources can be weighted based on associations with an existing list of words and phrases associated with a folksonomy, a frequency associated with the number of times the resource has been accessed in response to a search, or in other suitable manners. The method then proceeds to 108 where the weight is applied to each associated resource. The method then proceeds to 110.

At 110, words and phrases are extracted from the resources. In one exemplary embodiment, frequency, prominence, or other suitable factors can be used to extract words and phrases. The method then proceeds to 112.

At 112, it is determined whether a grammatical filter should be applied. If it is determined that a grammatical filter should not be applied, the method proceeds to 118, otherwise the method proceeds to 114 where the grammatical context for one or more words or phrases is determined. In one exemplary embodiment, a grammatical context can include a determination of whether the word is a noun, verb, adjective, or other suitable grammatical categories. In another exemplary embodiment, equivalent phrases can be identified by ignoring commonly used connecting words, words having the same or a related meaning, or in other suitable manners. The method then proceeds to 116 where a grammatical filter is generated. In one exemplary embodiment, the grammatical filter can be used to group equivalent words or phrases for weighting purposes, search purposes, or other suitable grammatical filters can be generated. The method then proceeds to 118.

At 118, it is determined whether any words or phrases should be deleted. If it is determined that no words or phrases should be deleted, the method proceeds to 122, otherwise the method proceeds to 120 where predetermined words or phrases are deleted. In one exemplary embodiment, obscene, misleading, or other predetermined words or phrases can be deleted so as to improve the quality of the words and phrases associated with a topic. The method then proceeds to 122.

At 122, a weighting factor for each word or phrase is determined. In one exemplary embodiment, the weighting factor can be based on the number of times a word or phrase was used in a resource, the number of resources a word or phrase was used in, the weight of the resource (if any) that a word or phrase was found in, or other suitable factors. The method then proceeds to 124.

At 124, it is determined whether an update to a list of terms and phrases is required. If no update is required, the method proceeds to 128, otherwise the method proceeds to 126 where words or phrases are added to or deleted from a list associated with the folksonomy. In one exemplary embodiment, a list can be generated at 126, an existing list can be checked to determine whether any new terms should be added or deleted (such as based on minimum weights, predetermined list sizes or other suitable factors), or other suitable processes can be implemented. In another exemplary embodiment, the list can be implemented as an associative database that allows one or more Internet resources to be associated with each word or phrase, so as to allow a user to search the associative database by submitting a query comprising words or phrases and to receive a ranked list of Internet resources based on the weightings associated with the words or phrases contained in the query. The method then proceeds to 128.

At 128, it is determined whether modification of weights for words or phrases is required. If updating of weights is not required, the method proceeds to 132 and ends, otherwise the method proceeds to 130 where weights are modified. In one exemplary embodiment, any words or phrases that have a new weight based on new information obtained from the folksonomy resources can be updated, weights associated with Internet resources for words or phrases can be updated, weights can be normalized, or other suitable processes can be used. The method then proceeds to 132 and terminates.

In operation, method 100 utilizes folksonomy to generate a weighted search term list or database, grammatical filters and other suitable data and algorithms to provide folksonomy weighted search and advertising placement.

The present invention recognizes that when a word is used, it is used in the context of other words which serve to reveal the meaning or the value of that word when used in Internet communication. In one exemplary embodiment, a word such as “hook” may typically be found in association with the words “fish” or “fishing.” Further, the words “fish” or “fishing” may also be found in association with the words “fresh water” or “salt water.” And still further the words “fresh water” or “salt water” may also be found in association with the words “sport” or “commercial.” Thus, the disclosed algorithm for monitoring a word and the words associated with that word as used by a user is able to place the word into a context which matches the interests of the user of that word.

More specifically, the folksonomy method of the present invention is a weighted compilation of words or phrases extracted from a list of references. These references might be expressed as websites, blogs, forums, new feeds, databases or other applications. The words and phrases derived from the list of references are then used to compile a list.

In the hook example, the repeated use of the word “hook” together with the words “ocean,” “sea,” and/or “salt water” and with the words “charter” and/or “sport” will create an association for future use of the word “hook” with deep sea fishing. Over time, other words may enter into the references such as “sailfish.” Increased frequency and currency of the use of the word “sailfish” will further focus the meaning of the word “hook” to deep sea fishing for sailfish. But if the word “sailfish” starts to be used less frequently in favor of the word “swordfish” the focus for the word hook will change.

Because those with similar interest will tend to use similar words and phrases, the words on the list will be a set of words associated with the interests of those using website, blogs, forums, news feeds, databases and other suitable sources that are built around a common interest.

Unlike in a static taxonomy, the disclosed folksonomy method can adjust the words or phrases on the list by frequency of use, the weighting of certain words or phrases and addition or deletions of words or phrases.

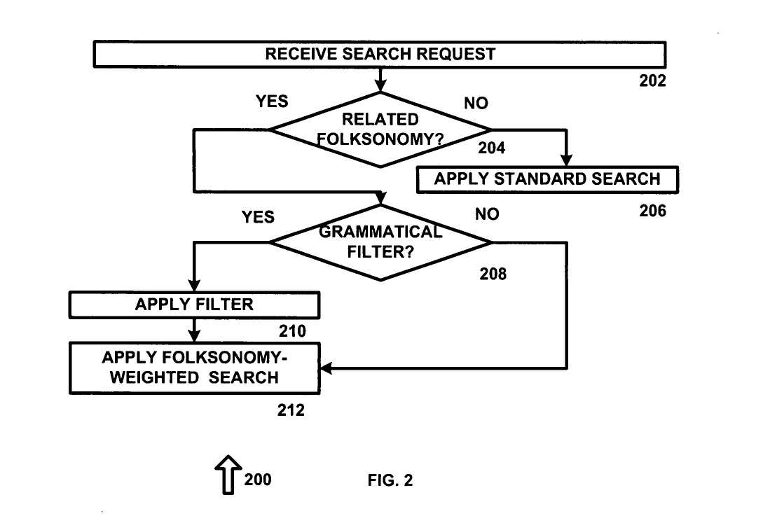

FIG. 2 is a diagram of a method 200 for providing a folksonomy searching system in accordance with an exemplary embodiment of the present invention. Method 200 can be implemented as an algorithm on a general purpose computing platform or other suitable systems.

Method 200 begins at 202, where a search request is received. In one exemplary embodiment, the search request can include a selected topic associated with a selected folksonomy, can be a search request consisting of a number of words or phrases, or can be other suitable search requests. The method then proceeds to 204.

At 204, it is determined whether a related folksonomy exists. If it is determined that no related folksonomy exists, the method proceeds to 206 where a standard search is perform. Otherwise, the method proceeds to 208, such as by selecting the related folksonomy, selecting a folksonomy having a highest weight, or in other suitable manners.

At 208, it is determined whether a grammatical filter should be applied. If it is determined that a grammatical filter should not be applied, the method proceeds to 212, otherwise the method proceeds to 210 where the grammatical filter associated with the folksonomy is applied. In one exemplary embodiment, the search request can include a word or phrase that has an associated word or phrase for the applied folksonomy, such that the filter replaces such words or phrases with the words or phrases for that folksonomy. Likewise, other filters can also or alternatively be applied. The method proceeds to 212 where a folksonomy weighted search is performed, such as by identifying websites, blogs, forums, news feeds, databases or other suitable resources that are built around a common interest, and that are ranked based on the relevance of the various resources to the search request. In one exemplary embodiment, the search can be performed utilizing a list, associative database, or other suitable data structures that allow one or more Internet resources associated with the words or phrases from the search to be provided to the user, such as where the Internet resources having a highest weight or rank are provided in descending order of weight or rank.

In one exemplary embodiment, a user may have a special interest in the JAVA programming language. This interest in the JAVA programming language will lead the user to seek out: web based references describing the JAVA programming language; news about changes or updates to the JAVA programming language; forums at which students of the JAVA programming language can discuss changes to be made in next generations of the JAVA programming language, or simply chat rooms in which users of the JAVA programming language can voice complaints, share tips and tricks, or ask questions of one another. By use of the disclosed folksonomy search method, the lexicon of words and phrases used to communicate about the JAVA programming language will go into a list. The list can be used to make associations among words or phrases based on the relevance of the resource to the search term, and the words and phrases on the list and the weighting of the words and phrases on the list can change based on changes in the use of the search terms within the various resources. In this exemplary embodiment, when the user elects to do a search for something with regard to JAVA programming language, the user will not be led through a maze of websites regarding JAVA in the sense of coffee or JAVA in the sense of the large island which is part of Indonesia. Instead, the words or phrases on the list will be used to refine the search based on the weight given to the words or phrases on the list, grammatical filters, or other processes. Accordingly, on such searches for information regarding “JAVA” and “programming language,” the disclosed folksonomy method can associate a term such as “JAVA” with other words or phrases such as “programming language” thereby leading to a more relevant search result.

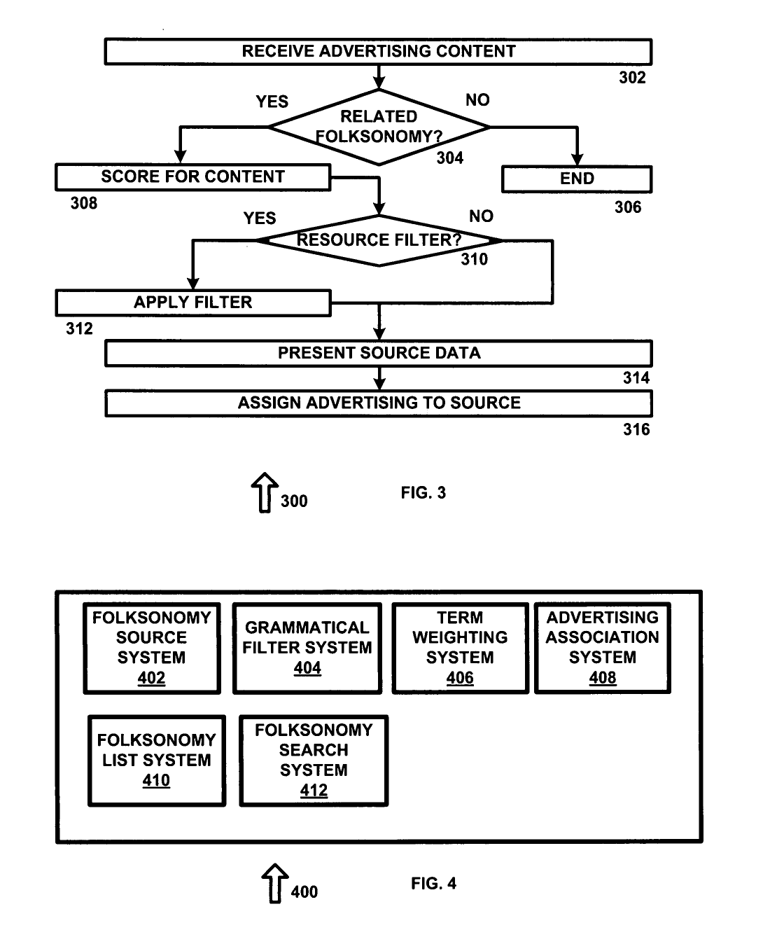

FIG. 3 is a diagram of a method 300 for providing a folksonomy advertisement placement system in accordance with an exemplary embodiment of the present invention. Method 300 begins at 302 where advertising content is received. In one exemplary embodiment, the advertising content can include words and phrases that will appear in the advertising, one or more folksonomy identifiers, information identifying parties that may be interested in the advertising, or other suitable data. The method then proceeds to 304.

At 304, it is determined whether there is a related folksonomy or folksonomic data. If it is determined that there is no related folksonomy or folksonomic data, the method terminates at 306. Otherwise, the method proceeds to 308 where the folksonomy or folksonomic data is scored based on the advertising content, such as to identify resources that have the strongest affiliation with the advertising data. The method then proceeds to 310 where it is determined whether to apply a resource filter. If no filter is required, the method proceeds to 314, otherwise the method proceeds to 312 where a filter is applied. In one exemplary embodiment, an advertiser may select certain resource categories to advertise on, such as web sites, chat rooms or other such resources. Likewise, the advertiser may select resources not to advertise on, sources may select advertisers that they do not want to receive advertising from, or other suitable filters can be applied. The method then proceeds to 314.

At 314, source data can be presented to an advertiser, such as to allow the advertiser to select resources for presentation of the advertising content. Likewise, where method 300 is used dynamically to select advertising on the fly, 314 can be omitted. The method then proceeds to 316.

At 316, advertising content is assigned to one or more sources, such as web sites, blogs, forums, news feeds, databases or other suitable Internet resources, such as to allow the advertising content to be displayed at that time, when that source is accessed, or in other suitable situations.

In operation, method 300 allows advertising to be placed based on a weighted folksonometric analysis of Internet resource content, so as to optimize the placement of advertising on web sites, blogs, forums, news feeds, in pop-ups, or in other suitable locations.

In one exemplary embodiment, a user that operates a commercial fishing business in the Great Lakes and is interested in finding information about hooks used for commercial fishing operations may enter the words “hook,” “Great Lakes” and “commercial” into a search engine. The folksonometric weighted search and advertising placement system method disclosed herein can be used to identify that the user has an interest in fresh water commercial fishing hooks. A seller of fresh water commercial fishing hooks can utilize the same weighted folksonomy to place advertising on the search results page, on related web sites, blogs, forums, or other such Internet resources, just at the time when the interest in buying a fresh water commercial fishing hook is at its zenith. Providing relevant advertisement greatly increases the chances of an advertiser registering a sale, and satisfying both the advertiser and consumer.

The present invention achieves further technical advantages by selectively routing communication over the Internet through the folksonomy weighted search and advertisement placement, by providing an enhanced recognition of selected words amid phrases, and thereby add greater meaning to the use of selected words or phrases in Internet communication.

FIG. 4 is a diagram of a system 400 for providing folksonomy weighted search and advertisement placement in accordance with an exemplary embodiment of the present invention. System 400 can be implemented in hardware, software or a suitable combination of hardware and software and can be one or more software systems operating on a digital signal processing platform or other suitable processing platforms. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

System 400 includes folksonomy source system 402, which can include web sites, blogs, forums, news feeds and other suitable Internet resources that can be used to provide folksonomy words and phrases for predetermined topics. In one exemplary embodiment, folksonomy source system 402 can be populated utilizing search engine results, web crawler results, manual selection, or in other suitable manners.

Grammatical filter system 404 provides grammatical filtering for words and phrases based on the results of searches performed by folksonomy search system 412. In one exemplary embodiment, grammatical filter system 404 can determine whether a word is a noun, verb, adjective or other suitable grammatical category, can determine by the relationship between words whether equivalent phrases or words exist in a folksonomy, and can generate suitable rules for processing Internet resources for a folksonomy, searches, or for other suitable applications.

Term weighting system 406 applies a term weighting based on folksonometric search results. In one exemplary embodiment, a word or phrase can be weighted based on the frequency that the term or phrase occurs on predetermined Internet resources, the prominence of the word or phrase, or other suitable factors.

Advertising association system 408 utilizes folksonomy weighted search results to determine optimal placement of advertising content, such as by performing folksonometric analysis of the advertising, application of filters, or in other suitable manners.

Folksonomy list system 410 generates, stores and updates folksonometric lists, such as lists generated by analyzing Internet resources such as web sites, chat rooms, blogs, news feeds or other suitable resources. In one exemplary embodiment, folksonomy list system 410 associates words and phrases with Internet resources for use in folksonomy weighted searching and advertising placement, such as using a list, an associative database, or other suitable data structures.

Folksonomy search system 412 allows a user to perform searching using a folksonomy related search, such as by allowing a user to select a predetermined folksonomy, by assigning the search to a folksonomy based on the search terms used, or in other suitable manners. In one exemplary embodiment, words and phrases entered into a search engine by a user can be filtered using grammatical filters and assigned to a folksonomy, and search results can be returned based on the weighting assigned to the search terms within the folksonomy and the Internet resources assigned to the search terms.

In operation, system 400 performs folksonomy weighted search and advertising placement by identifying folksonomies, analyzing Internet resources to establish weightings for words and phrases and associated Internet resources, and utilizing the folksonomy weighted word and phrase data for searching and advertising placement. System 400 thus provides optimized searching and advertising placement through the use of folksonomy and the weighting of words and phrases based on folksonomy.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method for folksonomy weighted searching comprising:
identifying two or more Internet resources associated with a folksonomy;
identifying one or more words or phrases in the Internet resources;
weighting the words or phrases based on a frequency of use; and
generating a database associating the words or phrases with at least one of the Internet resources.

2. The method of claim 1 wherein weighting the words or phrases based on the frequency of use comprises weighting the words or phrases based on a frequency of use in the Internet resources.

3. The method of claim 1 wherein weighting the words or phrases based on the frequency of use comprises weighting the words or phrases based on a frequency of use in the Internet resources and a weight associated with one or more of the Internet resources.

4. The method of claim 1 wherein generating the database associating the words or phrases with at least one of the Internet resources comprises assigning a weight to one or more of the Internet resources.

5. The method of claim 1 further comprising weighting one or more of the Internet resources.

6. The method of claim 1 further comprising weighting one or more of the Internet resources based on a frequency of access.

7. The method of claim 1 further comprising associating advertising with one or more of the Internet resources based on a weight associated with one or more of the words or phrases.

8. The method of claim 1 further comprising:
receiving a search request; and
identifying one or more of the Internet resources based on a correlation between the search request and the one or more words or phrases.

9. A method for folksonomy weighted advertisement placement comprising:
receiving a search request;
identifying one or more Internet resources associated with the search request based on a weighted folksonomy;
identifying advertising content associated with the search request based on the weighted folksonomy; and
providing the one or more Internet resources and the advertising content in response to the search request.

10. The method of claim 9 wherein providing the one or more Internet resources and the advertising content in response to the search request comprises including the advertising content and a list of the one or more Internet resources.

11. The method of claim 9 wherein providing the one or more Internet resources and the advertising content in response to the search request comprises embedding the advertising content within one or more of the Internet resources.

12. The method of claim 9 wherein providing the one or more Internet resources and the advertising content in response to the search request comprises providing the advertising content as a pop-up when a user selects one or more of the Internet resources.

13. A system for folksonomy weighted searching comprising:
a folksonomy source system storing two or more Internet resources; and
means for weighting words or phrases associated with a folksonomy in the two or more Internet resources.

14. The system of claim 13 further comprising a grammatical filter system applying a grammatical filter to the words or phrases.

15. The system of claim 13 further comprising a folksonomy list system generating a data structure for associating the words or phrases with the two or more Internet resources.

16. The system of claim 13 further comprising an advertising association system associating advertising content with a search request.

17. A system for folksonomy weighted advertising comprising:
an advertisement association system receiving advertising content; and
means for associating the advertising with one of two or more Internet resources based on a weighted folksonomy.

18. The system of claim 17 further comprising means for filtering the Internet resources based on the advertising content.

19. The system of claim 17 further comprising means for scoring two or more weighted folksonomies based on the advertising content.

20. The system of claim 17 further comprising means for selecting one of the two or more Internet resources based on the advertising content.

21. A method for folksonomy weighting comprising:
receiving two or more Internet resources associated with a folksonomy;
identifying a plurality of words and phrases in the Internet resources;
assigning a weight to one or more of the words or phrases based on the Internet resources;
storing the words or phrases in a database; and
associating each of the stored words or phrases with one or more Internet resources.

22. The method of claim 21 further comprising:
receiving a search request;
locating one or more of the words or phrases in the database using the search request; and
generating a list of the Internet resources associated with the one or more located words or phrases.

23. The method of claim 22 wherein generating the list of the Internet resources associated with the one or more located words or phrases comprises:
determining a weight for each of the associated Internet resources; and
listing the associated Internet resources in order of decreasing weight.
